(19) United States
(12) Patent Application Publication
(10) Pub. No.: US 2013/0258817 A1
(43) Pub. Date: Oct. 3, 2013

(54) STRUCTURE OF A WRISTWATCH

(71) Applicant: Antonio Corvino, Milano (IT)

(72) Inventor: Antonio Corvino, Milano (IT)

(21) Appl. No.: 13/994,652

(22) PCT Filed: Dec. 9, 2011
(86) PCT No.: PCT/IB11/55592

§ 371 Date: Jun. 14, 2013

(30) Foreign Application Priority Data
Dec. 15, 2010 (IT) MI2010A002293

(51) Int. Cl. G04B 37/14

(52) U.S. Cl. CPC G04B 37/14
USPC 368/29; 368/204

(57) ABSTRACT

The wristwatch structure consists of a case containing the movement, the battery, and all of the mechanisms necessary for the functioning of a classic timepiece. The case stays suspended due to the force of magnets set inside the case, which are repelled by an equal number of magnets in the base frame that are arranged in such a way that they have the same polarity as those in the case. The case can also include a light diffuser and a contact that turns on the light when the case touches the base, thereby illuminating the hands, the hours, and the date on the dial.

The subject of the present invention is a wristwatch structure.

As is well known, the wristwatch has always been an object with strong aesthetic and design features, and designers are constantly looking for new structures, whether in terms of aesthetics or functionality.

The task of the present invention is to create a new and original wristwatch structure.

As part of this task, one purpose of the invention is to create a wristwatch structure that has a strong technological feature.

Another purpose is to create a wristwatch structure that is functional.

With regard to its particular construction characteristics, the present wristwatch structure is capable of ensuring the broadest possible guarantee of reliability and safety of use.

This and other purposes, which are described in more detail below, are achieved by a wristwatch structure characterised by the fact that it consists of a case containing the movement, the battery, and all of the mechanisms necessary for the functioning of a classic timepiece. The case stays suspended due to the force of magnets set inside the case, which are repelled by an equal number of magnets in the base frame that are arranged in such a way that they have the same magnetic field as those in the case.

The latter also consists of a contact that enables a light to come on when the case touches the base, thereby illuminating the hands, the hours, and the date on the dial.

Further features and advantages of the subject of the present invention are highlighted in greater detail through an examination of the description of a preferred, though not exclusive, form of construction for the invention, as illustrated in the attached designs, which are merely a representative sample and are not exhaustive, namely:

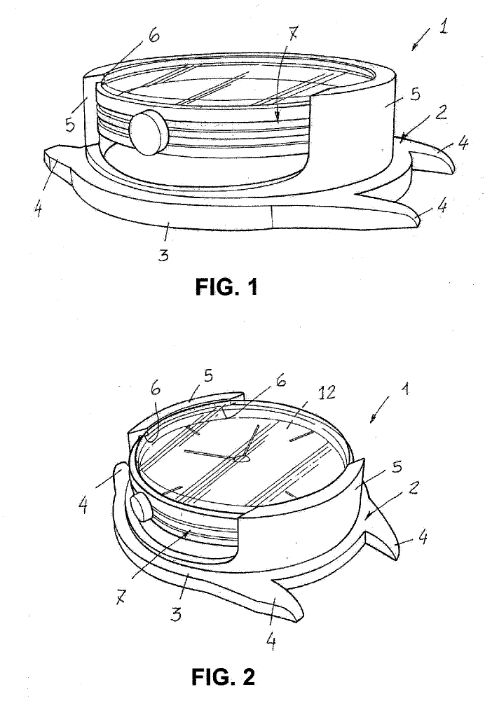

FIG. 1 is a perspective view of the structure of the wristwatch, according to the present invention;

FIG. 2 is another perspective view of the structure of the watch;

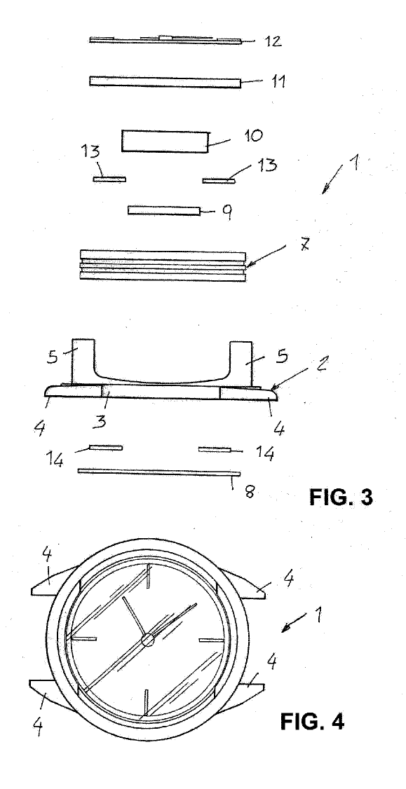

FIG. 3 is an exploded side elevation view, which shows the components of the structure of the watch;

FIG. 4 is a plan view of the structure of the watch that is the subject of the present invention.

With particular reference to the numerical symbols in the aforementioned figures, the structure of the wristwatch, according to the invention, indicated globally in FIG. 1, comprises a base frame 2 and consists of an annular-shaped part 3 that has clasp components 4 for fastening a watchband.

Extending from the annular-shaped part 3 are lateral retaining components 5, preferably consisting of semi-circular walls, which include a top-edge retainer 6.

The inside of the lateral walls 5 encloses the watchcase 7, which is capable of moving vertically but is retained at the top by the edge of the retainer 6 of the lateral walls and at the bottom by a plate 8 attached to the base frame 2 where it meets the annular-shaped part 3.

The case 7 contains the movement 10, the battery 6, and all of the mechanisms necessary for the functioning of a classic timepiece.

At the top, the case furthermore includes a light diffuser 11 and a dial 12.

According to the present invention, the case 7 is suspended or floats due to the force exercised by one or more magnets 13 set inside the case, which are repelled by fixed magnets 14 set in the base frame 2.

The magnets 13 in the case and the fixed magnets 14 are arranged in such a way that they have the same field, one facing the other, thereby repelling one another.

Inside the case 7, there is also a contact that enables a light to come on when the case touches the base 8, thereby illuminating the hands, the hours, and the date on the dial 12.

It has been established in practice that the invention achieves the predetermined task and purposes.

It represents the creation of a new and original “suspended” watch structure whose case floats within a retaining frame.

The base frame has sides that are suitably open so as to permit visual appreciation of the suspension of the case.

Of course, the materials used, as well as the size, can be varied to meet the required needs.

1. A wristwatch structure characterised by the fact that it consists of lateral retaining components and a top-edge retainer which include a case containing the movement, the battery, and all of the mechanisms necessary for the functioning of a classic timepiece wherein magnets set inside the case, repelled by an equal number of magnets in the a base frame and are arranged in such a way that they have the same polarisation as those in the case so that the case stays suspended.

2. A watch structure, according to claim 1, characterised by the fact that the base frame consists of an annular-shaped part that has clasp components for fastening a watchband and from which extend lateral retaining components for the case.

3. A watch structure, according to claim 1, characterised by the fact that the lateral retaining components consist of semi-circular walls which include the top-edge retainer whose interior side encloses the watchcase, which is capable of moving vertically but is retained at the top by the edge of the retainer of the lateral walls and at the bottom by a plate attached to the base frame where it meets the annular-shaped part.

4. A watch structure, according to claim 1, characterised by the fact that, at the top, the case includes a light diffuser and the dial.

5. A watch structure, according to claim 1, characterised by the fact that the case also consists of a contact that enables a light to turn on when the case touches the base, thereby illuminating the hands, the hours, and the date on the dial.
